(19) United States
(12) Patent Application Publication
(10) Pub. No.: US 2026/0154361 A1
(43) Pub. Date: Jun. 4, 2026

(54) DEVICE AND METHOD TO PROCESS AND PAIR DISCRETE STRINGS OF CONTINUOUS TEXT WITHIN A DATASET

(71) Applicant: Antonio Castillo, Atlanta, GA (US)

(72) Inventor: Antonio Castillo, Atlanta, GA (US)

(21) Appl. No.: 18/966,031

(22) Filed: Dec. 2, 2024

(51) Int. Cl. G06F 16/955; G06F 16/334

(52) U.S. Cl. CPC G06F 16/9566; G06F 16/3344; G06F 16/3347

(57) ABSTRACT

A device and method to receive an input of URL links, generate 301 redirects by pairing discrete strings of continuous text, and output the 301 redirects in a final table. The redirect device may be configured to process a URL data script, keyword script, URL matching script, and final table builder script. The device uses natural language libraries that treat a URL as a continuous string of text in a dataset to find the best one-to-one match in the dataset using a calculated similarity score.

### FIELD

The subject matter disclosed herein relates to a system for matching URLs and more particularly relates to a system for pairing URLs in a dataset to one or many URLs in a different dataset using predetermined criteria.

### DESCRIPTION OF THE RELATED ART

A 301 redirect is triggered when a link to a webpage cannot be found. U.S. Pat. No. 12,003,369 (Rodrigo) discloses a redirect server configured within a service-based architecture (SBA) domain of a wireless communication network. The server handles configuration signaling to update the location of resources or services within the SBA domain.

### BACKGROUND

With the growth of the internet and the proliferation of web-based services, managing web traffic and ensuring smooth access to online resources have become critical for businesses and service providers. One of the key technologies employed in web traffic management is the use of HTTP redirects, specifically HTTP status code 301, which indicates that a requested resource has been permanently moved to a new Uniform Resource Locator (URL). When a web server responds with a 301 status code, web browsers and search engines update their cached links to reflect the new URL, ensuring future requests for the resource are directed to the correct location.

The 301 redirect is essential for website administrators, especially when restructuring websites, changing domain names, or migrating content. It helps in maintaining the Search Engine Optimization (SEO) rankings of a webpage by transferring its ranking power to the new URL and prevents users from encountering broken links. Furthermore, it reduces unnecessary server load caused by outdated links.

However, implementing and managing 301 redirects can be complex, especially in large-scale environments where multiple domains, subdomains, and resources are being redirected. The existing solutions often involve manual configuration within web server settings or content management systems (CMS), which can be time-consuming and prone to errors.

There is a need for an efficient, automated 301 redirect device that simplifies the process of managing and implementing 301 redirects across various web architectures. Such a device would provide a streamlined solution for configuring and maintaining redirects, ensuring seamless user access to resources and maintaining the integrity of search engine rankings. Additionally, the device would reduce administrative overhead and errors.

### SUMMARY

It is an object of the present system to automate the process of configuring, implementing, and managing 301 redirects in a manner that is scalable, efficient, and user-friendly.

Embodiments herein include a device with one or more processors to receive an input of URL links, which indicate a webpage that cannot be found or accessed by an end user, or one that a server administration intends to redirect to a new destination. The device generates 301 redirects, based on the input of URL strings and paired meta data. Each of the 301 redirects are generated by pairing discrete strings of continuous text. The device may output the 301 directs in a final table with a confidence score for the best 1:1 match or a set of options for the best match based on data provided.

Embodiments herein also include a method of pairing discrete strings of continuous text within a dataset. The steps include: receiving, by a device, an input of URL links, wherein the URL links each indicate a webpage for the end user. The method also includes the step of generating 301 redirects, based on the input of URL links. Additionally, the method includes the step of providing the 301 redirects in a final table.

Embodiments herein further include a non-transitory computer-readable medium storing instructions that, when executed by one or more processors, cause the one or more processors to. receive an input of URL links. The URL links may include broken URL links, which indicate a webpage that cannot be found or accessed by an end user, or links that a server administration intends to redirect to a new destination. The non-transitory computer-readable medium may generate 301 redirects by pairing discrete strings of continuous text and output the 301 redirects in a final table.

### BRIEF DESCRIPTION OF DRAWINGS

FIG. 1 is a schematic block diagram illustrating one embodiment of the 301-redirect device.

FIG. 2 is a schematic flowchart diagram illustrating one embodiment of a method of determining 301-redirect matches.

FIG. 2a is a schematic flowchart diagram illustrating the URL processing step in one embodiment of a method.

FIG. 2b is a schematic flowchart diagram illustrating the Keyword processing step in one embodiment of a method.

FIG. 2c is a schematic flowchart diagram illustrating the URL matching step in one embodiment of a method.

FIG. 2d is a schematic flowchart diagram illustrating the Final table builder step in one embodiment of a method.

FIG. 3 is an example implementation of a Final table including characteristics used to pair URLs.

### DETAILED DESCRIPTION OF THE DISCLOSURE

A “broken link” refers to a URL that does not exist or cannot be found by a user on the World Wide Web, whereby the requested resource on the server generates a 404 response code. When a user clicks on a broken link, they will typically encounter an error message, such as “404 Not Found” or “The requested URL was not found on this server.” If the user typed the correct URL then the various reasons for this error, include, but are not limited to: URL structure of the site recently changed without a redirect (e.g. URL taxonomy changes during a website migration, which can be any activity that transfers website architecture services and content from one web server to a new web server); the website is no longer available, is offline, or has been permanently moved; the linked content has been deleted; or there may be broken elements within the page (e.g. HTML, JavaScript).

A redirect may also be implemented as part of regular website maintenance. At the time of implementation, the original link is active and not broken. The website owner is changing the taxonomy of the URL for purposes such as ‘readability’ or ‘optimization.’ Redirects implemented in this manner would be more impactful to support a business strategy is changing URL taxonomy to something different.

When the URLs change there is often a manual or rudimentary programmatic effort to map the old URL to a new URL. A user encountering a broken link may encounter one of the following system messages: “404 Page not found: the page does not exist on the server”; “400 Bad Request: host server cannot understand the URL on your page”; “Empty: host server returns empty response with no content and no response code”; “Timeout: HTTP requests timed out during link check.” A user that encounters these errors may be likely to navigate away from the site as a result. Additionally, broken links will adversely affect Search Engine Optimization (SEO) ranks.

The disclosed device uses URLs which are input into a database to match the data set with an appropriate URL. After input from the user, no manual process is required, as the process is entirely scripted and automatic. In this way, the web server administrator is not required to manually match the URL. A score is assigned to find the best match for each URL. This enables the user to take large data sets to match and redirect with speed and accuracy. The output is then saved to a computer readable medium and used to redirect the desired URLs.

Implementations described herein may enable a device to fix broken URLs in an efficient manner by using natural language libraries that treat a URL as a continuous string of text in a dataset to find the best one-to-one match in the dataset using a calculated similarity score. In this way, the device may assist a user in improving SEO rankings and reducing the amount of time required to fix the links, allowing resolution in minutes rather than hours or days.

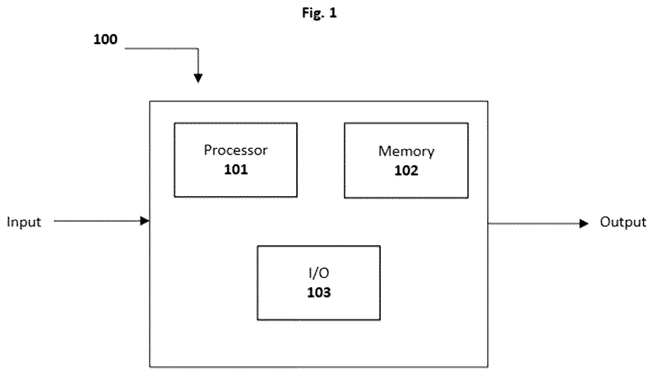

In implementations of a device to pair discrete strings of continuous text within a dataset, as shown in FIG. 1, may comprise a computing device (100) having a processor (101), memory (102), and an input/output (I/O) module (103). The processor (101) is configured to execute a set of instructions stored in the memory (102), which may include tasks such as data processing, computation, and control functions. The processor (101) may be any suitable type, including but not limited to, a microprocessor, microcontroller, or digital signal processor (DSP). The memory (102) stores the instructions and data required for the operation of the processor (101). The memory (102) may include volatile memory, such as random-access memory (RAM), and/or non-volatile memory, such as read-only memory (ROM) or flash memory. The input/output module (103) facilitates communication with external devices or systems, allowing for data exchange, user interaction, or connection to peripheral devices. The I/O module (103) may include various interfaces, such as Universal Serial Bus (USB), Ethernet, wireless communication interfaces, and others. It facilitates data exchange, user input, and output to external peripherals or networks. The I/O module (103) may also support input devices such as keyboards, mice, touchscreens, and output devices such as displays and printers. With the URLs used as inputs, each URL is taken and exploded into individual pieces for analysis.

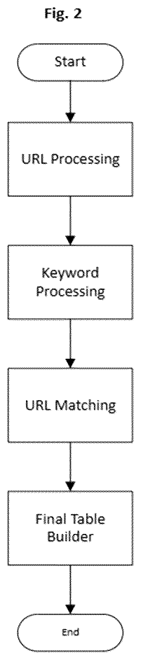

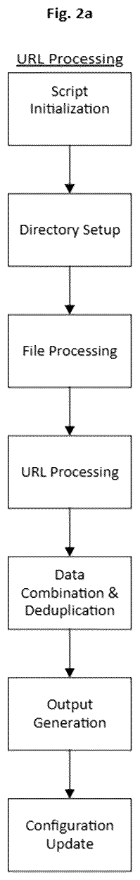

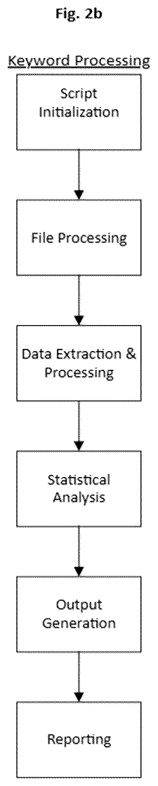

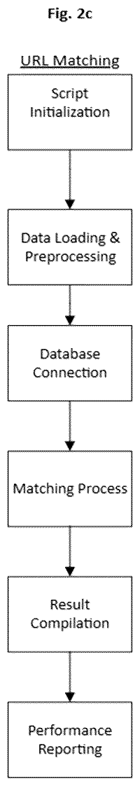

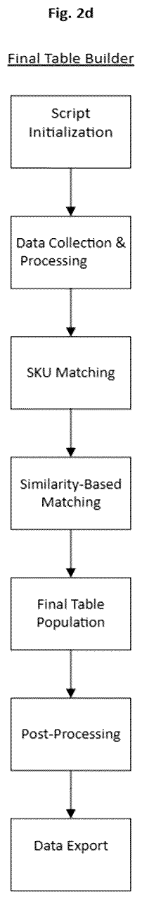

FIG. 2 illustrates the overall step-by-step process flow taken in the device. The initial step, URL Processing, uses a logic-based programming language to process URL data from comma-separated values (CSV) files by performing various operations such as data validation, URL sanitization, and unique ID generation. The logic-based programming language may be a Python script designed to handle multiple files, differentiating between origin and destination URLs. In the Keyword Processing step, keywords are extracted and manipulated from URLs, path segments and additional fields. This step handles both origin and destination URLs, generates various types of keywords, and provides statistical analysis of keyword lengths. In the following step, URL Matching, the logic-based programming language is used to perform URL Matching using various techniques including keyword analysis by cosine similarity, Levenshtein distance, and meta data such as title, description, or stock-keeping units (SKU) matching from mathematical measurement of these values in both datasets using cosine similarity. Cosine similarity analysis is accomplished by Text Preprocessing, Vector Creation, and Similarity Calculation. In the text preprocessing step, text is converted to lowercase and split into words. In the vector creation step each text is converted to a vector where each dimension represents a word, and the value in each dimension is the frequency of that word. In the step of similarity calculation the dot product of the vectors computed and divided by their magnitudes. The result being between 0 (completely different) and 1 (identical). The data is processed from text files and this step utilizes machine learning techniques for text analysis, and interacts with a database for data storage and retrieval. At the Final Table Builder step, a master table is built by processing and combining data from multiple sources. Large datasets are handled efficiently using parallel processing and batch operations. A logic-based programming language performs data aggregation, similarity calculations, and final match determinations for URL redirections.

As shown in FIG. 2a, the URL Processing feature includes a logic-based programming language that processes URL data from CSV files, performing various operations such as data validation, URL sanitization, and unique ID generation. Overall, this feature is designed to handle files from multiple directories, differentiating between origin and destination URLs. Throughout this portion of the process, error handling and logging are performed. The script includes error checking for file existence, CSV structure, and data validity in addition to printing informative messages about the processing status and counts of dropped URLs.

The Script Initialization step sets up directory paths and optionally accepts a ‘match_id’ as a command-line argument. The Directory Setup step checks for the existence of, and if necessary, creates input and output directories.

At the File Processing step, the most recent CSV files in specified directories are identified, and the structure of the files are validated using the following operations:
□‘get_most_recent_file(directory, file_extension)’:
Finds the most recent file with a specified extension in a given directory.

□‘validate_csv_columns(file_path)’:
Checks if the CSV files have the required columns (URL, and SKU if applicable).
Ensures the files don't have more than 3 columns.

□‘preprocess_csv(file_path)’:
Creates a temporary file to handle potential formatting issues in the CSV.

At the URL Processing step, each CSV file is read and preprocessed, the URLs are sanitized by removing Unified Threat Management (UTM) parameters, unique IDs are generated for each URL, and the origin and destination URLs are differentiated. UTM parameters are used for the administration and security of networks. The URL Processing step includes the following operations:
□‘remove_utm_parameters(url)’:
Removes UTM parameters from URLs.

□‘ensure_unique_id(url)’:
Generates a unique ID for each URL, handling potential duplicates.

□‘process_urls(file_path)’:
Main function for processing URLs from a CSV file.
Performs operations such as removing UTM parameters, generating unique IDs, and handling different column structures.

Data Combination and Deduplication combines processed data from all input files and removes duplicate entries. The Data Combination and Deduplication step includes the following operations:
□‘remove_duplicates(df)’
Removes duplicate entries based on URL and 301 type.

□‘process_files_in_multiple_directories(directories, output_directory)’:
Processes files from multiple directories.
Combines data from all processed files.
Applies URL filtering using a predefined list of URLs to drop.

At the Output Generation step, a new CSV file with processed data is created and includes unique IDs, sanitized URLs and additional metadata. Then a configuration file with the count of processed origin URLs is updated during the Configuration Update. The Output Generation step includes the following operation:
□‘update_config_value(key, value)’:
Updates a configuration file with new key-value pairs.

As shown in FIG. 2b, Keyword Processing includes a logic-based programming language that processes URL data from CSV files, extracting and manipulating keywords from URLs, path segments, and additional fields. Overall, this script is designed to handle both origin and destination URLs, generate various types of keywords, and provide statistical analysis of keyword lengths. The script uses a configuration file to set parameters such as: target levels for last path keyword extraction; the option to remove stop words from last path keywords; and the best destination Levenshtein length for recommendations. The stop words are removed from the URL field and the Dimension field. Additionally, the script identifies cases where input files or directories are not found and prints informative messages about the processing status and file locations.

The Script Initialization step sets up directory paths and loads stop words from configuration.

At the File Processing step, the most recent CSV file in the input directory is identified. The File processing step includes the following operations:
□‘find_most_recent_csv(directory)’:
Identifies the most recent CSV file in a specified directory.

□‘load_stop_words( )’:
Loads a list of stop words from a configuration file.

The Data Extraction and Processing step comprises reading the CSV file and processing each row; extracting keywords from URLs, path segments, and additional fields; and applying various cleaning and processing steps to keywords. The Data Extraction and Processing step includes the following operations:
□‘extract_keywords_from_url(url)’:
Parses URLs to extract keywords from path segments and query parameters.
Handles URL encoding, camelCase splitting, and file extension removal.

□‘extract_last_path_keywords(url, url_type)’:
Extracts keywords from an additional ‘dimension1’ field.

□‘clean_keywords(keywords)’:
Removes stop words and empty strings from keyword lists.

The Statistical Analysis step calculates length statistics for origin and destination keywords, and recommends a Levenshtein distance length based on configuration or statistics. The Levenshtein distance is a string metric for measuring the difference between two sequences and is determined as a distance between two words is the minimum number of single-character edits required to change one word into the other. The Statistical Analysis step includes the following operations:
□‘process_csv(file_path)’:
Reads the CSV file and processes each row.
Creates data packages containing various extracted keywords and metadata.

□‘calculate_lengths(data_packages)’:
Calculates statistics on keyword lengths, including shortest, longest, and 80^{th} percentile.

The Output Generation step creates a new CSV file with processed data and includes extracted keywords and additional metadata. The Output Generation step includes the following operation:
□‘save_data_to_file(data, output_dir)’:
Saves processed data to a new CSV file with a unique filename.

Next, at the Reporting step statistics and recommendations are provided to the console.

As shown in FIG. 2c, the URL Matching feature includes a logic-based programming language that performs URL matching using various techniques including keyword similarity, Levenshtein distance, and SKU matching. The script processes data from CSV files, utilizes machine learning techniques for text analysis, and interacts with a PostgreSQL database for data storage and retrieval. The script also identifies where input dataframes might be empty and prints informative messages about the processing status, including configuration settings and progress updates.

During the Script Initialization step, the device sets up directories and imports necessary modules, and loads configuration settings.

At the Data Loading and Preprocessing step, the device reads the most recent CSV file and splits data into origin and destination data frames for different keyword types. The Data Loading and Preprocessing step loads the most recent CSV file from a specified directory, and preprocesses data by filling null values and filtering based on URL types and keyword presence.

A connection to a database is established at the Database Connection step. The Database Connection step includes the following operations:
□‘create_first_table_from_csv( )’:
Creates an initial database table from the CSV data.

□‘get_ids_from_sku_table( )’:
Retrieves IDs from the SKU matching table.

The Matching Process comprises performing SKU matching; executing Levenshtein distance matching on last path keywords; conducting cosine similarity matching on URL keywords; and performing cosine similarity matching on dimension 1 keywords. The dimension may include different structures including, but not limited to, structured alpha numeric syntax.

The device can enable and disable each category in the Matching Process. The Matching Process step includes the following operations:
□‘sku_matcher)_’:
Matches URLs based on SKU if enabled.

□‘batched_levenshtein_similarity_matcher( )’:
Performs matching based on Levenshtein distance for last path keywords.

□‘batched_cosine_similarity_matcher_url( )’:
Matches URLs based on cosine similarity of keywords extracted from URLs.
□‘batched_cosine_similarity_matcher_dimension1( )’:
Matches based on cosine similarity of keywords from an additional dimension.
□‘TfidVectorizer’:
Converts text data into TF-IDF vectors for cosine similarity calculations.

At the Result Compilation step, the device builds a master table, combining results from all matching techniques. The Result Compilations step includes the following operation.
□‘build_master_table( )’:
Combines results from various matching techniques into a final matched file.

At the Performance Reporting step, the device prints the number of URLs and the total execution time.

As shown in FIG. 2d, the Final Table builder includes a logic-based programming language designed to build a master table by processing and combining data from multiple sources. The script handles large dataset efficiently using parallel processing and batch operations; and performs data aggregation, similarity calculations, and final match determinations for URL redirections. Performance is optimized by parallel processing—utilizing ‘ProcessPoolExecutor’ for concurrent execution of data processing tasks; batch processing - implementing batch operations to reduce database interaction overhead; and efficient data structures - using dictionaries for quick lookups and data aggregation. Additionally, the batch sizes can be adjusted for performance tuning, and the database connection parameters are configurable.

During the Script Initialization step, the device sets up a database connection and creates the necessary tables.

At the Data Collection and Processing step, the device retrieves data from multiple tables using parallel processing, and aggregates data and calculates similarity scores. The Data Collection and Processing step includes the following operations:
□‘process_record_batch( )’:
Processes a batch of origin records, matching them with destination records based on similarity scores.

□‘process_sku_matches( )’:
Handles SkU-based matches for a batch of origin records.

□‘process_table_data( )’:
Extracts and processes data from individual tables in the database.

During SKU matching, the device processes SKU matches in batches using parallel execution. During Similarity-Based Matching, the device calculates sum similarities and determines the best matches, and processes similarity-based matches in batches using parallel execution. The Similarity-Based Matching step includes the following operations:
□‘batch_process_and_collect_results( )’:
Manages batch processing for SKU matches.

□‘batch_process_and_collect_similarity_results( )’:
Handles batch processing for similarity-based matches.

Next, at the Final Table Population step, matched records are inserted into the final match table. The Final Table Population step includes the following operation:
□‘build_master_table( )’:
Main function that orchestrates the entire process of building the master table.

At the Post-Processing step, the device updates a multiple matches field, and normalizes matching scores. Finally, at the Data Export step, the device exports the final match table to a CSV file.

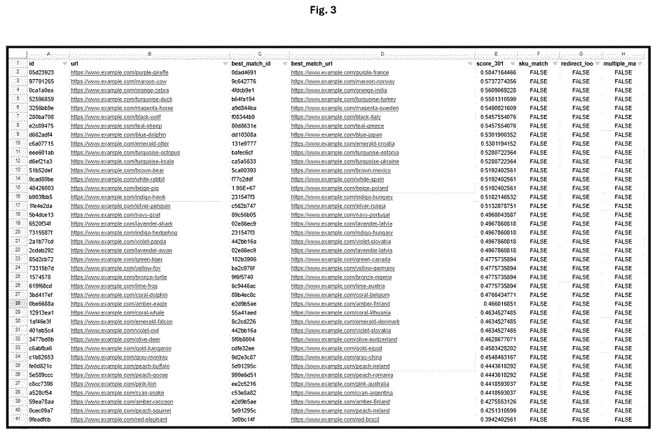

FIG. 3 illustrates an example of a Final table. The fields provide for the score (score_301) which is used to determine the best match for the 301 redirect. While the disclosure focuses on a matching value of at least 80 percent, the acceptable values can ultimately be determined by the user. A user can adjust the sensitivity (matching proximity of the characters) of the matching score. In this way, the user may be able to impose stricter or more lenient matching conditions.

While specific embodiments and implementations have been described herein, it should be understood that these are presented by way of example only, and not limitation. The methods, systems, and software described in this application may be implemented using various programming languages, frameworks, and architectures beyond those explicitly mentioned. Modifications, substitutions, and alternatives to the disclosed embodiments will be apparent to those skilled in the art. Such variations, alterations, and adaptations are considered to fall within the spirit and scope of the present invention as defined by the appended claims. Furthermore, the functionality described may be implemented in hardware, software, firmware, or any combination thereof, and may be distributed across multiple processing units or integrated into a single device. Therefore, the present invention is not limited to the specific implementations described herein but extends to other programming paradigms and technological solutions that achieve the same functional outcomes.

I/We claim:

1. A device comprising:
one or more processors to:
receive an input of URL links,
the URL links each indicating a webpage with URL taxonomy that is changing for an end user;
generate 301 redirects, based on the input of URL links, the 301 redirects are generated by pairing discrete strings of continuous text; and
output the 301 redirects in a final table.

2. The device of claim 1, where the one or more processors, when generating the 301 redirects are further to:
process a URL data script;
process a keyword script;
process a URL matching script; and
process a final table builder script.

3. The device of claim 2, wherein processing the URL data script comprises:
file handling and validation;
URL processing;
data transformation and combination; and
configuration management.

4. The device of claim 2, wherein processing the keyword script comprises:
file handling and data loading;
keyword extraction and processing;
data processing and analysis; and
output generation.

5. The device of claim 2, wherein processing the URL matching script comprises:
data loading and preprocessing;
creating an initial database table;
matching URLs based on meta data, Levenschtein distance, and cosine similarity;
text vectorization; and
result aggregation.

6. The device of claim 2, wherein processing the final table builder script comprises:
data processing;
batch processing and parallelization;
creating reference and final match tables;
building a final master table; and
exporting final match data to a CSV file.

7. The device of claim 1, wherein the one or more processors are further to:
check for and log errors.

8. A method comprising:
receiving, by a device, an input of URL links,
the URL links each indicating a webpage whose URL taxonomy is changing for an end user;
generating, by the device, 301 redirects, based on the input of URL links,
wherein the 301 redirects are generated by pairing discrete strings of continuous text; and
providing, by the device, the 301 redirects in a final table.

9. The method of claim 8, wherein:
the input of URL links is determined by a comprehensive URL report.

10. The method of claim 8, wherein generating the 301 redirects comprises:
processing a URL data script;
processing a keyword script;
processing a URL matching script; and
processing a final table builder script.

11. The method of claim 10, wherein processing the URL data script comprises:
script initialization;
directory setup;
file processing;
URL processing;
data combination and deduplication;
output generation; and
configuration update.

12. The method of claim 10, wherein processing the keyword script comprises:
script initialization;
file processing;
data extraction and processing;
statistical analysis;
output generation; and
reporting statistics and recommendations.

13. The method of claim 10, wherein processing the URL matching script comprises:
script initialization;
data loading and preprocessing;
database connection;
a matching process;
result compilation; and
performance reporting.

14. The method of claim 10, wherein processing the final table builder script comprises:
script initialization;
data collection and processing;
meta data matching;
similarity-based matching;
final table population;
post processing; and
data export.

15. A non-transitory computer-readable medium storing instructions, the instructions comprising:
one or more instructions that, when executed by one or more processors, cause the one or more processors to:
receive an input of URL links,
the URL links each indicating a whose URL taxonomy is changing for an end user;
generate 301 redirects, based on the input of URL links,
the 301 redirects are generated by pairing discrete strings of continuous text; and
output the 301 redirects in a final table.

16. The computer-readable medium of claim 15, wherein the one or more instructions, that cause the one or more processors to generate 301 redirects, further cause the one or more processors to:
process a URL data script;
process a keyword script;
process a URL matching script; and
process a final table builder script.

17. The computer-readable medium of claim 16, wherein the one or more instructions, that cause the one or more processors to process the keyword script, further cause the one or more processors to:
identify a most recent CSV file in a specified directory;
load a list of stop words from a configuration file;
parse the URLs to extract keywords from path segments and query parameters;
extract keywords from a specific segment of a path of the URL based on configuration;
process both path segments and query parameters;
extract keywords from a dimension field;
remove stop words and empty strings from keyword lists;
read and process each row of the CSV file, and create data packages containing various extracted keywords and metadata;
calculate statistics on keyword lengths; and
recommend a Levenshtein distance length based on configuration or statistics.

18. The computer-readable medium of claim 16, wherein the one or more instructions, that cause the one or more processors to process the URL matching script, further cause the one or more processors to:
loading the most recent CSV file from a specified directory;
preprocess data by filing null values and filtering based on URL category and keyword presence;
create an initial database table from CSV file data, and retrieving IDs from a SKU matching table; and
perform matching based on SKU, Levenshtein distance, and cosine similarity.

19. The computer-readable medium of claim 15, wherein the one or more instructions, that cause the one or more processors to generate 301 redirects, further cause the one or more processors to:
print informative messages about the processing status and progress.

20. The computer-readable medium of claim 19, wherein the one or more instructions, that cause the one or more processors to print informative messages about the processing status and progress, further cause the one or more processors to:
include counts of dropped URLs.
